(19) United States
(12) Patent Application Publication
(10) Pub. No.: US 2008/0104979 A1
(43) Pub. Date: May 8, 2008

(54) Dehumidifying method of airconditioning system for automotive windshield

(76) Inventor: Sung Mo Lee, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/648,881

(22) Filed: Dec. 29, 2006

(30) Foreign Application Priority Data
Nov. 7, 2006 (KR) 10-2006-0109677

(51) Int. Cl. G05D 23/00

(52) U.S. Cl. 62/157

(57) ABSTRACT

A method of controlling an air conditioning system includes comparing an ambient air temperature to a first predetermined temperature, comparing an elapsed operating time of a blower after switching off an air conditioner to a predetermined time if the ambient air temperature is above the predetermined temperature, and converting the air conditioning system to a floor mode if the elapsed operating time of the blower is below the predetermined time. If the ambient air temperature is below the first predetermined temperature, the method may compare a coolant temperature to a second predetermined temperature, and convert the air conditioning system to the floor mode if the coolant temperature is above the second predetermined temperature and the elapsed operating time of the blower is below the predetermined time. The first predetermined temperature may be about 0° C. The second predetermined temperature may be about 50° C. The predetermined time may be about 120 minutes.

### CROSS-REFERENCE TO RELATED APPLICATIONS

This application claims the benefit of Korean Patent Application No. 10-2006-0109677, filed on Nov. 7, 2006, in the Korean Intellectual Property Office, the disclosure of which is incorporated herein by reference.

### BACKGROUND

1. Field of the Invention

The present invention relates to a dehumidifying method of an air conditioning system for an automotive windshield, and more particularly, to a dehumidifying method that prevents condensation on the windshield at vehicle start-up.

2. Description of the Prior Art

A typical air conditioning system includes a defroster that eliminates moisture or frost on the windshield. However, if humid air inside the air conditioning system is discharged to the windshield, such as if humid air is stored in the system at vehicle start-up, the window gets fogged.

### SUMMARY OF THE INVENTION

Embodiments of the present invention provide a dehumidifying method of an air conditioning system for an automotive windshield that enables the humid air inside the air conditioning system to be discharged toward the floor for a predetermined time at vehicle start-up by using a floor purge logic of a control device in accordance with a signal transmitted from an ambient air temperature sensor and a cooling water temperature sensor of the air conditioning system. When the ambient air temperature is above about 0° C. and the accumulated operating time of a blower after switching off an air conditioner is below about 120 minutes, or when the ambient air temperature is below about 0° C., the cooling water temperature is above about 50° C., and the accumulated operating time of the blower after switching off the air conditioner is below about 120 minutes, the floor purge logic is performed.

The method may include a first step of determining whether an ambient air temperature detected from the temperature sensor is above a predetermined temperature; a second step of determining whether an operating time of a blower after switching off an air conditioner is elapsed by a predetermined time if the ambient air temperature is above the predetermined temperature; and a third step of automatically converting to a floor mode if the operating time of the blower is not elapsed above the predetermined time.

If the ambient temperature is below the predetermined temperature, a cooling water temperature is detected from the temperature sensor, and if the cooling water temperature is above a predetermined temperature, the method proceeds to the second step.

The predetermined temperature of the ambient air may be from −10° C. to 10° C., the predetermined temperature of cooling water may be from 30° C. to 70° C., and the predetermined operating time of the blower may be from 100 minutes to 140 minutes.

### BRIEF DESCRIPTION OF THE DRAWINGS

The above and other objects, features and advantages of the present invention will be more apparent from the following detailed description taken in conjunction with the accompanying drawing, in which:

FIG. 1 is a flow chart showing a dehumidifying method of an air conditioning system for an automotive windshield according to an embodiment of the present invention.

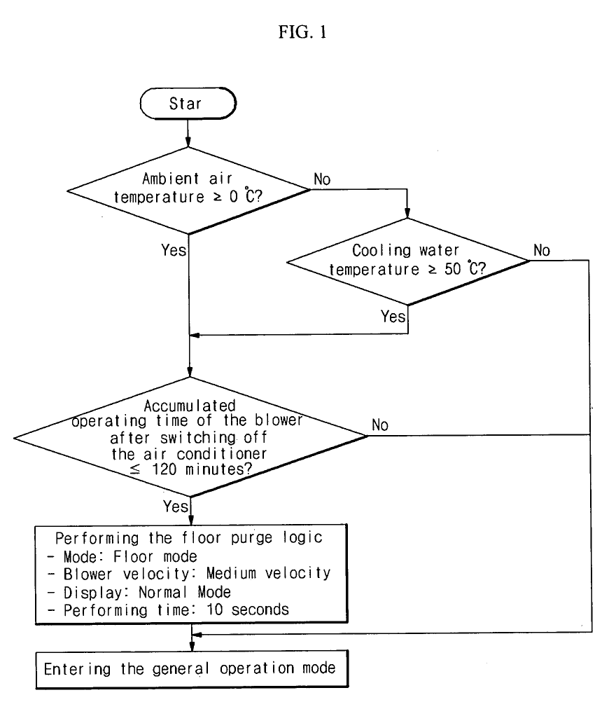

### DETAILED DESCRIPTION OF PREFERRED EMBODIMENTS

Hereinafter, the present invention will be described in detail with reference to the accompanying drawing.

Embodiments of the present invention prevent condensation on a windshield, caused by discharging the humid air inside an air conditioning system when the air conditioning system is operated at vehicle start-up, by using a floor purge logic of a control device in accordance with a signal transmitted from an ambient air temperature sensor and a cooling water temperature sensor of the air conditioning system.

In order to prevent humid air from being discharged to the windshield, the air discharged from the air conditioning system is directed toward the floor instead of being discharged through the defroster, and the air is discharged within a predetermined temperature range to maintain passenger comfort.

In a first step, if the ambient air temperature is above a first set temperature between about −10° C. and 10° C., for example 0° C., or if the ambient air temperature is below the first set temperature and the cooling water temperature is above a second set temperature between about 30° C. and 70° C., for example 50° C., the method proceeds to a second step.

The first step ensures that air directed to the floor is not excessively cold, thereby maintaining passenger comfort. This is accomplished either by the ambient air being above the first set temperature, or by the engine cooling water being above the second set temperature, so that the air discharged from the blower is warmed by the cooling water.

After the first step is carried out, if an accumulated operating time of the blower after switching off the air conditioner is below a set time between about 100 minutes and 140 minutes, for example, 120 minutes, that is, moisture in the air conditioning system and on the evaporator is insufficiently dried after the blower is operated, the floor purge logic is carried out.

Here, the floor purge logic controls opening and closing of vents, and directs the air toward the floor, such as by opening only the floor vents.

In this step, the wind velocity of the blower may be medium, and the operating time of the blower may be 10 seconds.

When the floor purge logic is carried out, the floor mode may not be notified to a driver, but may be displayed as a normal mode.

After the floor mode operating time (e.g. 10 seconds), a general operation mode is entered, which controls the air conditioning system, including the defroster, by returning to the user-set blower velocity, vent opening states, etc.

As described above, the dehumidifying method of the air conditioning system for the automotive windshield according to the present invention has an advantageous effect that condensation on the windshield when operating the air conditioning system at vehicle start-up is prevented.

Although preferred embodiments of the present invention have been described for illustrative purposes, those skilled in the art will appreciate that various modifications and changes thereof are possible without departing from the scope and spirit of the present invention, and all modifications and changes are intended to be included within the description of the claims.

What is claimed is:

1. A method of controlling an air conditioning system, comprising:
comparing an ambient air temperature to a first predetermined temperature;
comparing an elapsed operating time of a blower after switching off an air conditioner to a predetermined time if the ambient air temperature is above the predetermined temperature; and
converting the air conditioning system to a floor mode if the elapsed operating time of the blower is below the predetermined time.

2. The method of claim 1, further comprising, if the ambient air temperature is below the first predetermined temperature, comparing a coolant temperature to a second predetermined temperature, wherein the converting the air conditioner system to the floor mode is carried out if the coolant temperature is above the second predetermined temperature and the elapsed operating time of the blower is below the predetermined time.

3. The method of claim 1, wherein the first predetermined temperature is about 0° C.

4. The method of claim 2, wherein the second predetermined temperature is about 50° C.

5. The method of claim 1, wherein the predetermined time is about 120 minutes.
